(19) United States
(12) Patent Application Publication
(10) Pub. No.: US 2016/0239629 A1
(43) Pub. Date: Aug. 18, 2016

(54) SYSTEMS AND METHODS FOR TRANSITION CARE MANAGEMENT

(71) Applicant: Phyzit Inc., Little Rock, AR (US)

(72) Inventors: Stephen James Canon, Little Rock, AR (US); Michael Jackson Canon, Midland, TX (US); Brendan Keith Moore, Little Rock, AR (US); Larry Jay Wilson, Benton, AR (US); Stewart Alexander Whaley, Little Rock, AR (US)

(21) Appl. No.: 15/042,314

(22) Filed: Feb. 12, 2016

Related U.S. Application Data
(60) Provisional application No. 62/115,320, filed on Feb. 12, 2015.

(51) Int. Cl. G06F 19/00

(52) U.S. Cl. CPC G06F 19/3418

(57) ABSTRACT

Methods, systems, and apparatus, including computer programs encoded on a computer storage medium, for determining that an action is to be performed, and in response, selecting a telemedicine session action to be performed, the telemedicine session action associated with a user; based on selecting the telemedicine session action, identifying a complexity level associated with a medical condition of the user, the medical condition associated with the telemedicine session action; determining that the complexity level includes a first complexity level, and in response, identifying i) a first communication event and ii) a first time threshold associated with the first communication event; and determining that the first time threshold is satisfied, and in response, satisfying the first communication event.

### CROSS-REFERENCE TO RELATED APPLICATIONS

This application claims priority to U.S. Provisional Application Ser. No. 62/115,320, filed on Feb. 12, 2015, which is hereby incorporated by reference in its entirety.

### SUMMARY

This specification relates to assisting primary care providers and patients with transition care management (TCM).

In general, innovative aspects of the subject matter described in this specification can be embodied in methods that include actions of determining that an action is to be performed, and in response, selecting a telemedicine session action to be performed, the telemedicine session action associated with a user; based on selecting the telemedicine session action, identifying a complexity level associated with a medical condition of the user, the medical condition associated with the telemedicine session action; determining that the complexity level includes a first complexity level, and in response, identifying i) a first communication event and ii) a first time threshold associated with the first communication event; and determining that the first time threshold is satisfied, and in response, satisfying the first communication event.

Other implementations of this aspect include corresponding systems, apparatus, and computer programs, configured to perform the actions of the methods, encoded on computer storage devices.

These and other implementations can each optionally include one or more of the following features. For instance, the first complexity level includes a high complexity level. Determining that the complexity level includes a second complexity level, and in response, identifying a second time threshold associated with the first communication event. Determining that the second time threshold is satisfied, and in response, satisfying the first communication event. The second time threshold being less than the first time threshold. The first communication event including a face-to-face medical session to be performed that is associated with the user. Determining that the action is to be performed further includes, in response, selecting a message action, the message action including providing a message to the user. Based on selecting the message action, identifying i) a second communication event and ii) a third time threshold associated with the second communication event;

determining that the third time threshold is satisfied, and in response, determining whether the user has provided a response to the message action; in response to determining that the user has provided the response to the message action, satisfying the second communication event; and in response to determining that the user has not provided the response to the message action, performing a third communication event, and in response, satisfying the second communication event. The third time threshold being less than the first time threshold. The second communication event including an initial communication to be provided to the user. The third communication event including an additional communication to be provided to the user. Selecting the message action occurs prior to selecting the telemedicine session action.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which a transition care management (TCM) system provides services.

FIGS. 2A-2L depict example screenshots in accordance with implementations of the present disclosure.

FIGS. 3A-3B, 4A-4B, and 5 depict example processes that can be executed in accordance with implementations of the present disclosure.

Like reference numbers and designations in the various drawings indicate like elements.

### DETAILED DESCRIPTION

Implementations of the present disclosure are generally directed to assisting primary health care providers and patients with transition care management (TCM). More particularly, implementations of the present disclosure are directed to capturing and analyzing data that is associated with a patient, and data associated with interactions between the patient and the primary health care provider, e.g., a health care workflow. Based on such analysis, a TCM system can compare the data to event thresholds and associated time thresholds to improve the patient-care experience for the patient and the health care provider.

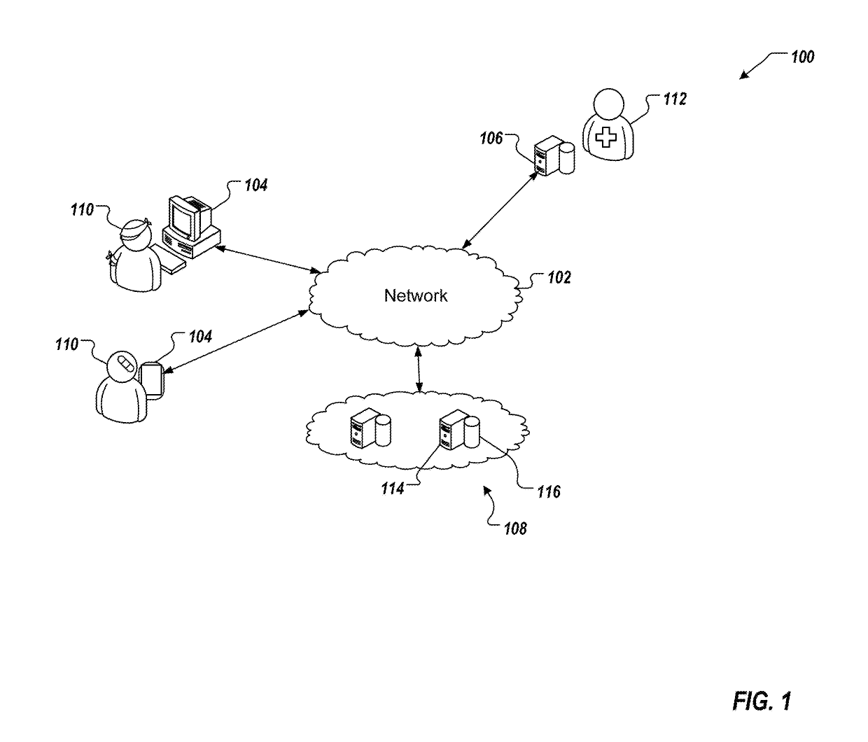

FIG. 1 depicts an example environment 100 in which patients and primary care providers interact with the TCM process. The example environment 100 includes a network 102, e.g., a local area network (LAN), wide area network (WAN), the Internet, or a combination thereof, connects patient user computing systems 104, a health care provider computing system 106, and a TCM system 108. In some examples, the network 102 can be accessed over a wired and/or a wireless communications link. For example, mobile computing devices, such as smartphones can utilize a cellular network to access the network 102. The environment 100 may include any number of patient computing systems 104 and health care provider computing systems 106.

In some examples, the patient computing system 104 and the health care provider computing system 106 is an electronic device that is capable of requesting and receiving data over the network 102. Example computing systems include personal computers, laptop computers, and mobile computing devices, e.g., smartphones and/or tablet computing devices, that can send and receive data over the network 102. A smartphone, e.g., a phone that is enabled to communicate over the Internet, is an example of a mobile device. A patient computing device 104 and a health care provider computing system 106 can execute a user application, e.g., a web browser, to facilitate the sending and receiving of data over the network 102. Each patient computing device 106 is associated with a respective patient 110; and each health care provider computing system 106 is associated with a respective health care provider 112.

In some examples, the TCM computing system 108 facilitates connectivity between the patient computing system 104 and the health care provider computing system 106. That is, the TCM computing system 108 provides interactivity with the TCM process for the patient 110 and the health care provider 112, described further below. The TCM computing system 108 can include one or more computing systems 114, and one or more databases 116. In some examples, the TCM computing system 108 can be a backend computing system, e.g., off-site, from the view point of the patient computing systems 104 and the health care provider computing system 106.

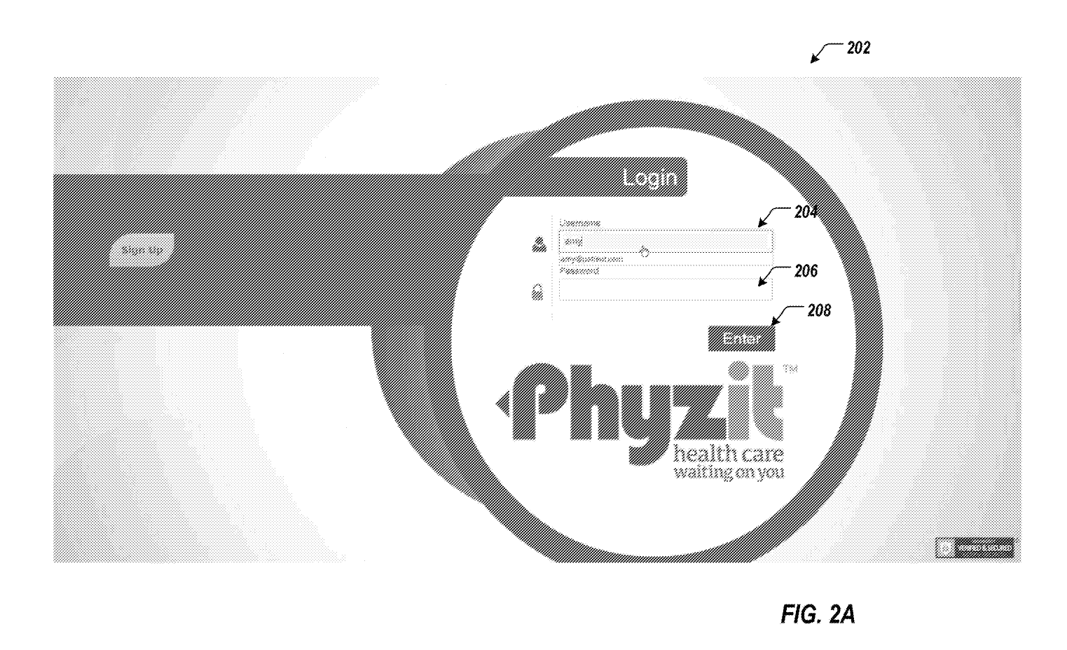

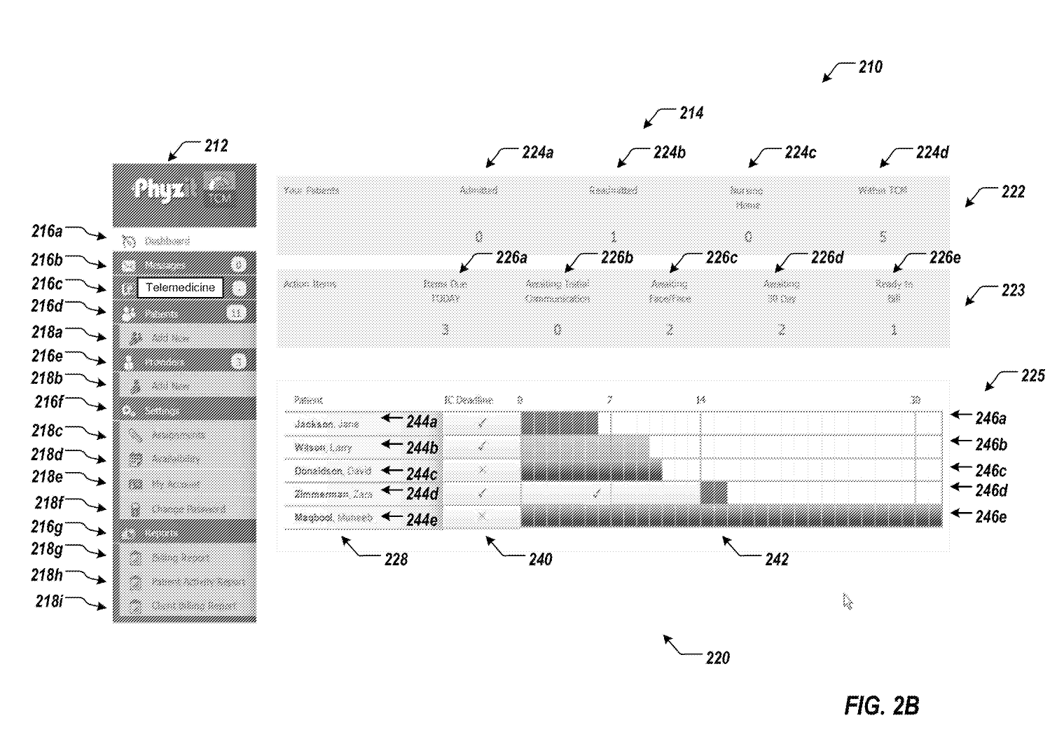

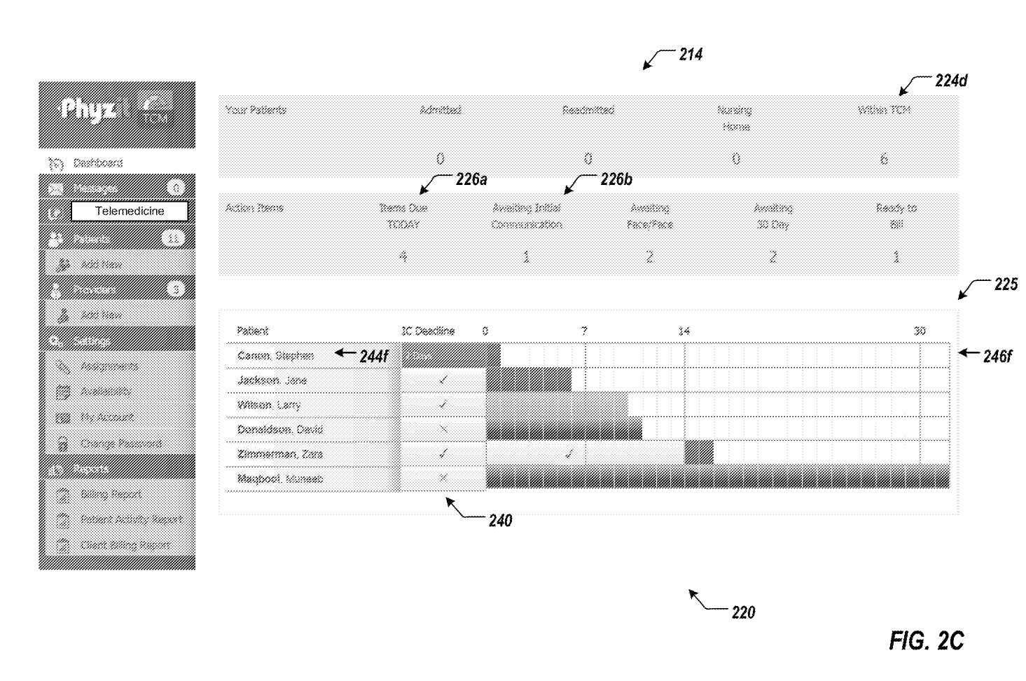

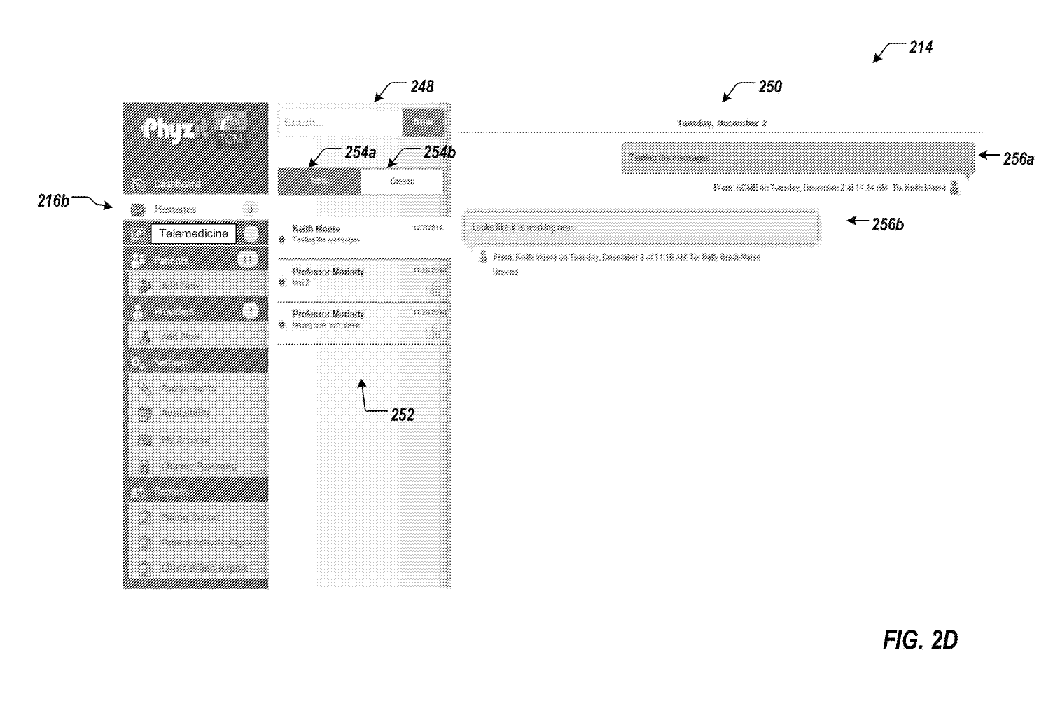

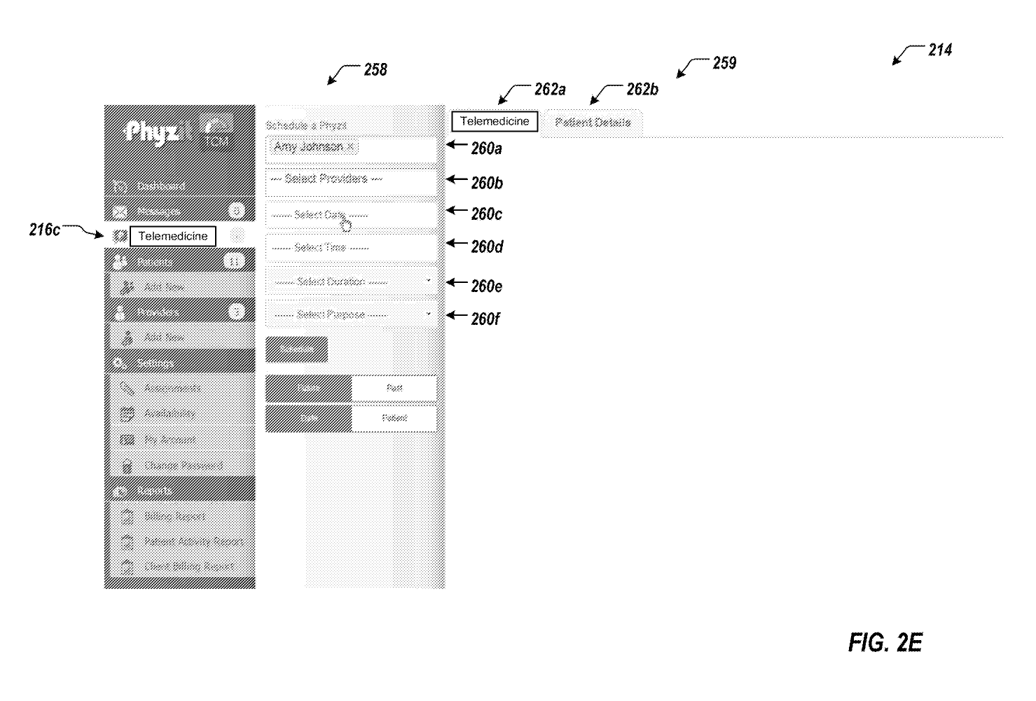

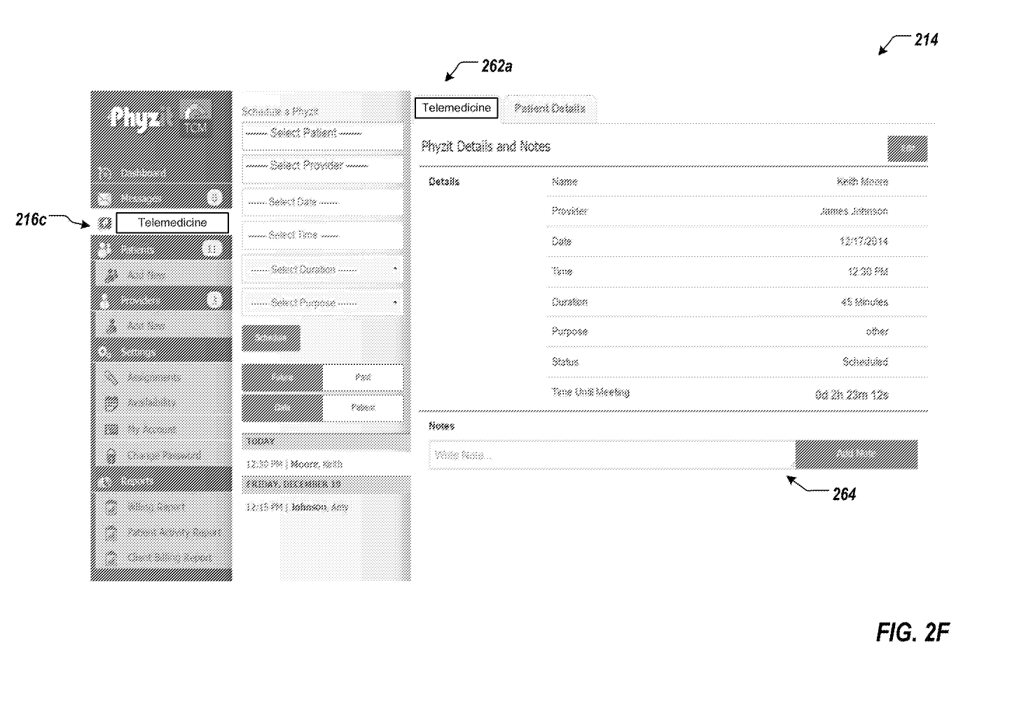

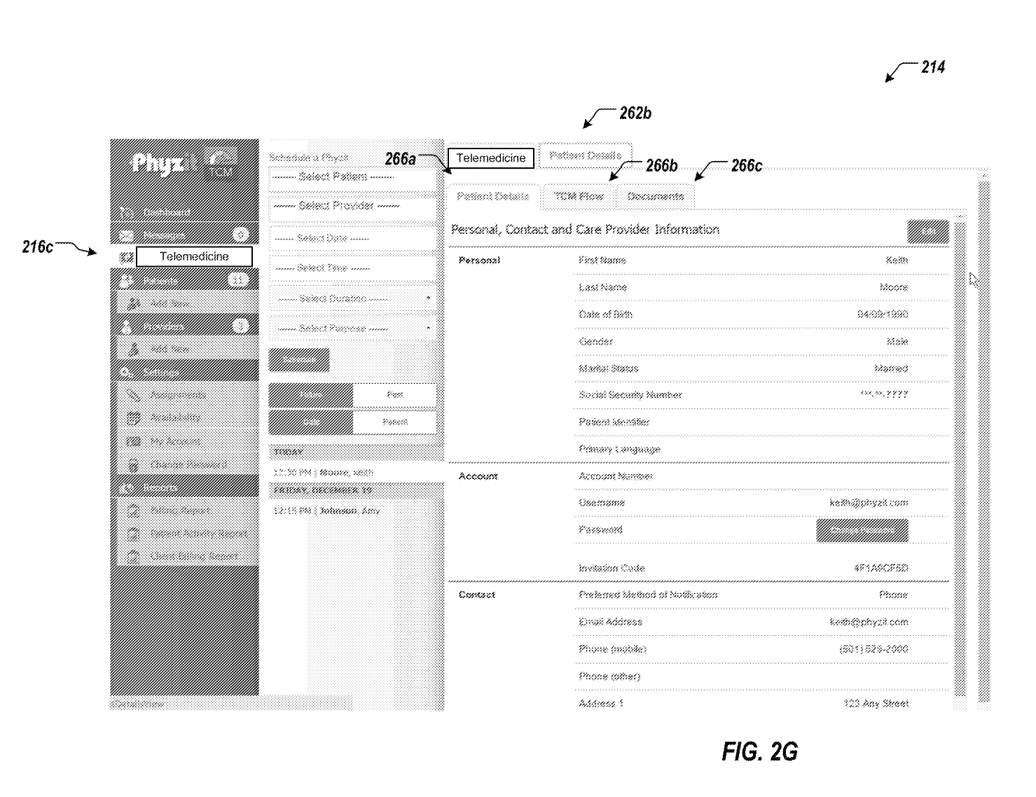

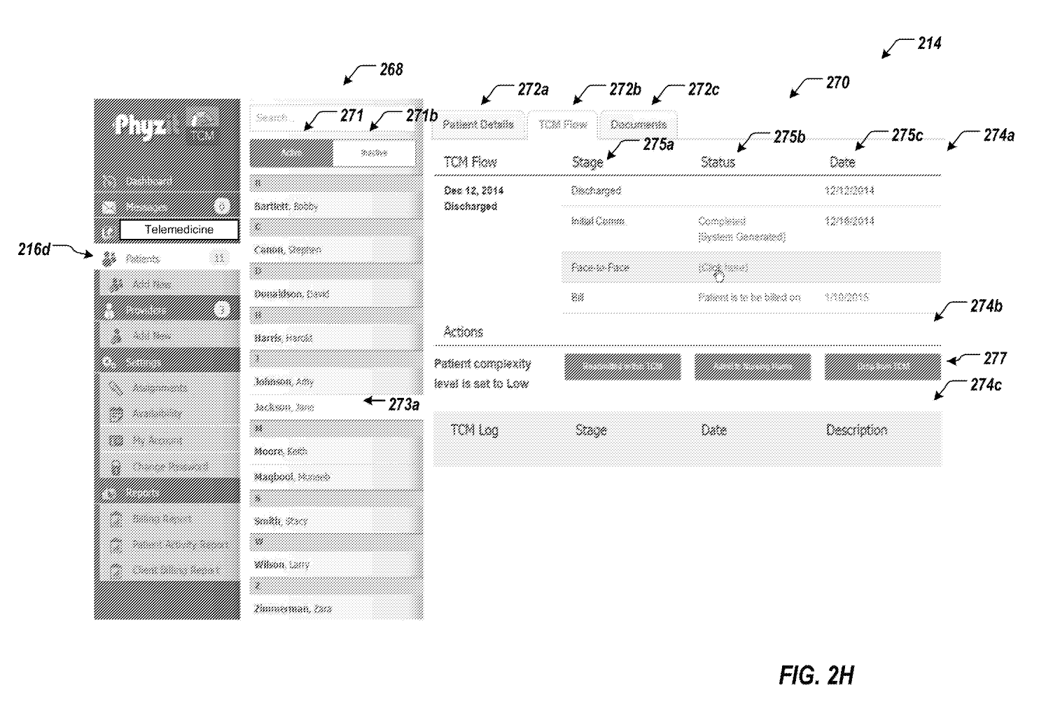

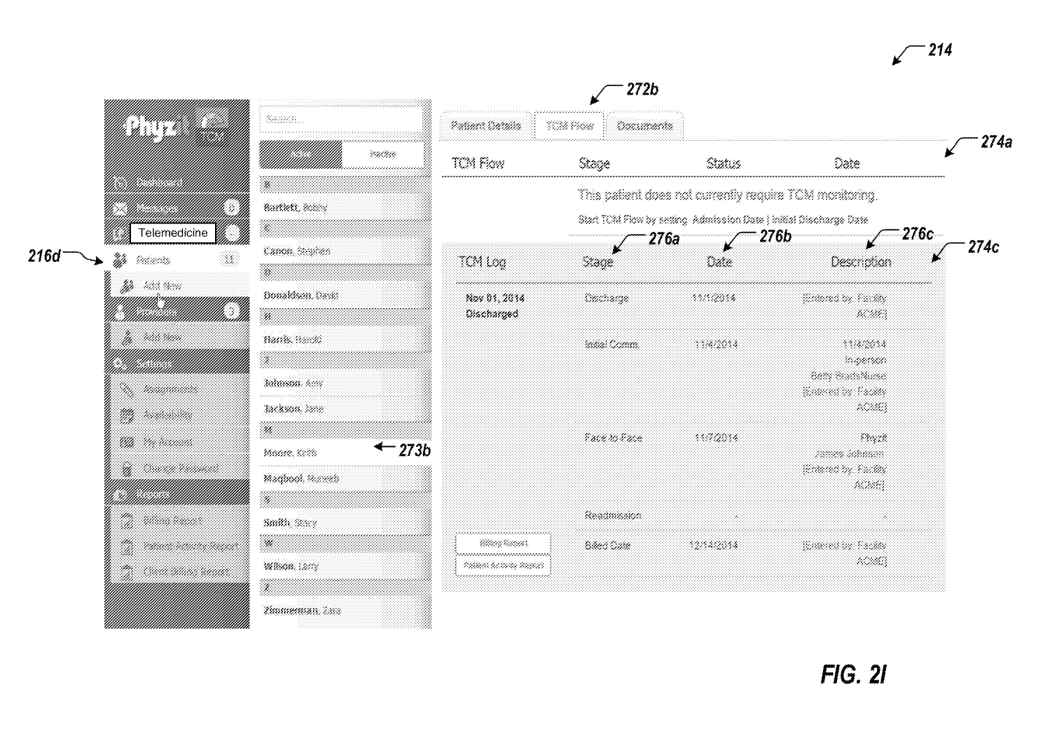

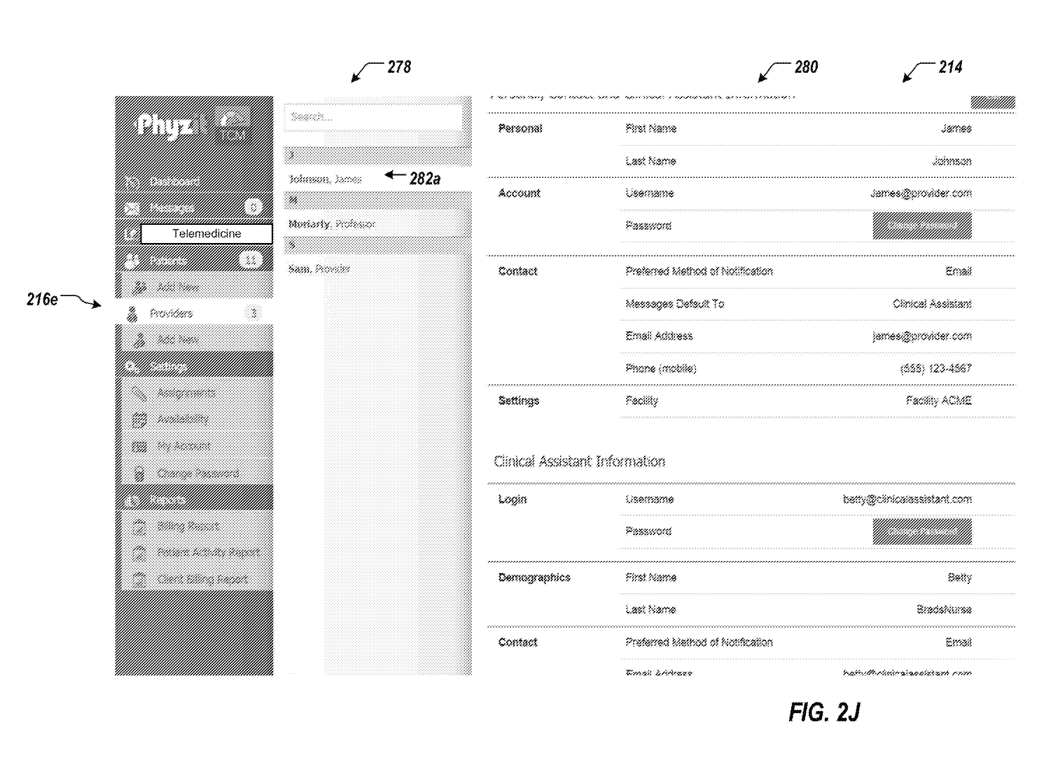

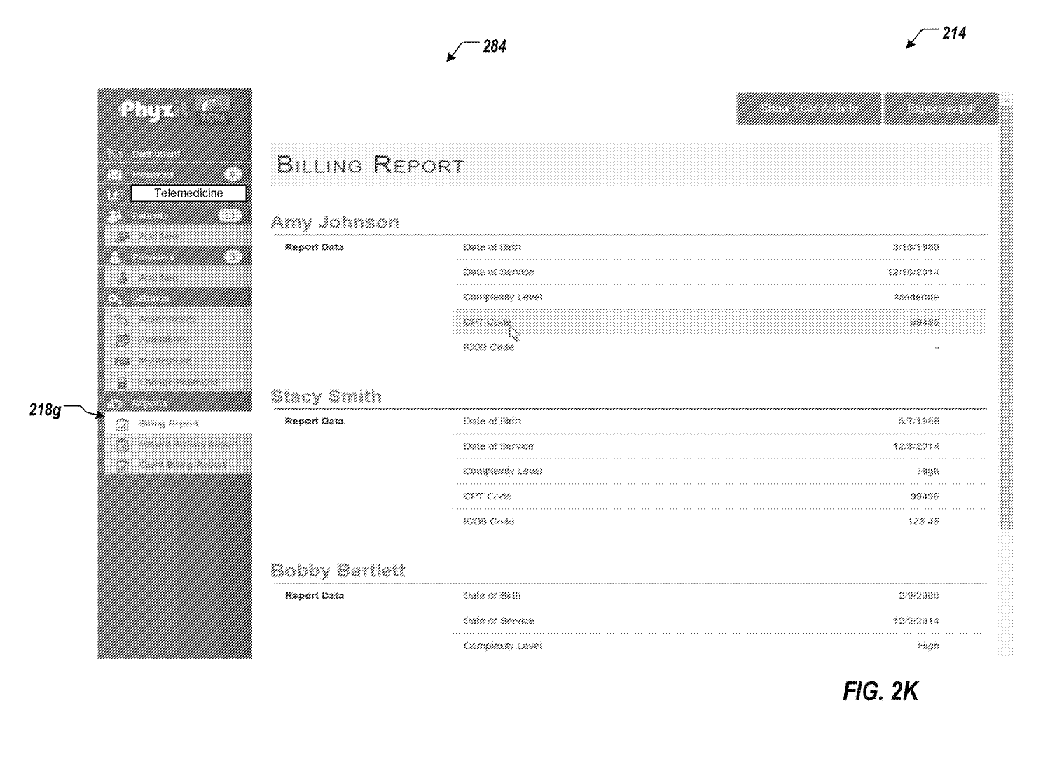

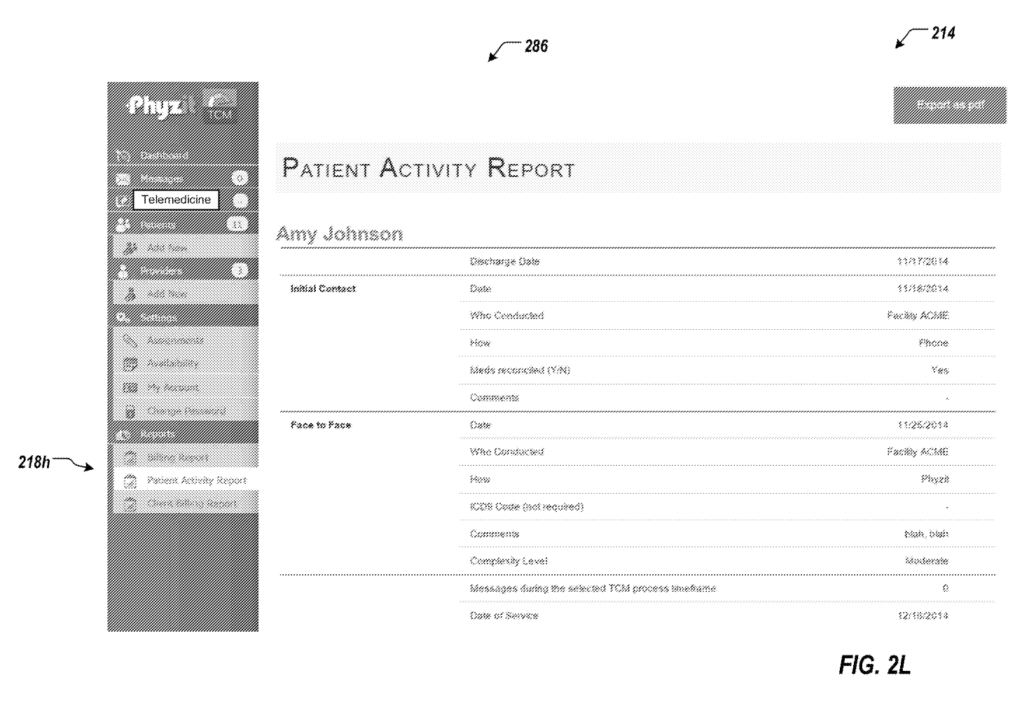

FIGS. 2A-2L depict example screenshots in accordance with implementations of the present disclosure. FIGS. 2A-2L illustrate one or more electronic documents provided by the TCM computing device 108 to the patient computing system 104 and the health care provider computing system 106 in the TCM process. In some examples, the electronic documents can include web page electronic documents.

FIG. 2A illustrates a login electronic document 202 associated with the TCM process. The login electronic document 202 includes a username entry field 204, a password entry field 206, and a selectable button 208. A patient, e.g., the patient 110, can provide login credentials, e.g., through the patient computing system 104, to the username entry field 204 and the password entry field 206 to gain access to the TCM process. Further, a health care provider, e.g., the health care provider 112, can also gain access to the TCM process by providing login credentials to the login electronic document 202. The healthcare provider can manage associated clients and client records, among other health care related activities.

FIG. 2B illustrates a dashboard GUI 210. The dashboard GUI 210 is associated with the health care provider, e.g., the health care provider 112. That is, the dashboard GUI 210 is provided to the health care provider, e.g., through the health care computing device 106, upon the health care provider providing login credentials to gain access to the TCM process. The dashboard GUI 210 includes a sidebar 212 and a display region 214. The sidebar 212 includes a dashboard category 216a, a messages category 216b, a telemedicine category 216c, a patients category 216d, a providers category 216e, a settings category 216f, and a reports category 216g (collectively referred to as categories 216). The sidebar 212 provides navigation of the display region 214 in that when one of the categories 216 is selected, the information that is displayed in the display region 214 is updated appropriately, e.g., based on the selected category 216. The sidebar 212 can include any number of categories.

In addition, one of more of the categories 216 can include a sub-category. For example, the patients category 216d includes an add new sub-category 218a; the providers category 216e includes an add new sub-category 218b; the settings category 216f includes an assignments sub-category 218c, an availability sub-category 218d, a my account sub-category 218e, and a change password sub-category 218f; and the reports category 216g includes a billing report sub-category 218g, a patients activity report sub-category 218h, and a client billing report sub-category 218i (collectively referred to as sub-categories 218). The sub-categories are also selectable such that, when selected, the information that is displayed in the display region 214, is updated appropriately, e.g., based on the selected sub-category 218. Each category 216 can include any number of sub-categories 218.

In the illustrated example of FIG. 2B, the dashboard category 216a is selected and the display region 214 is updated to show a dashboard 220. The dashboard 220 is associated with the health care provider that provided the login credentials, as mentioned above. That is, the dashboard 220 displays information relevant to the particular health care provider. The dashboard 220 includes a patients region 222, an action item region 223, and a time graph region 225. The patients region 222 displays information of patients that are associated with the health care provider, e.g., patients that are under the care or supervision of the health care provider. The patients region 222 includes an admitted category 224a, a readmitted category 224b, a nursing home category 224c, and a within TCM category 224d (collectively referred to as categories 224). The categories 224 provide a general overview of the patients associated with the health care provider, and a status of such as defined by the categories 224. In some examples, the admitted category 224a is associated with patients currently admitted to a health care management facility, e.g., hospital; the readmitted category 224b is associated with patients currently readmitted to a health care management facility; the nursing home category 224c is associated with patients currently under the care of a nursing home; and the TCM category 224d is associated with patients currently within the TCM process. In the illustrated example, the particular health care provider has zero patients associated with the admitted category 224a, one patient associated with the readmitted category 224b, zero patients associated with the nursing home category 224c, and five patients associated with the TCM category 224d.

The action item region 223 displays information of action items that are associated with the particular health care provider. The actions items region 223 includes an items due today category 226a, an awaiting initial communication (IC) category 226b, an awaiting face-to-face communication (FF) category 226c, an awaiting thirty day category 226d, and a ready to bill category 226e (collectively referred to as categories 226). The categories 226 provide a general overview of actions items to be taken by the health care provider, and a status of such action items. In the illustrated example, the health care provider has three items associated with the items due today category 226a, zero items associated with the awaiting IC category 226b, two items associated with the awaiting FF category 226c, two items associated with the awaiting thirty-day category 226d, and one item associated with the ready to bill category 226e. In some examples, an action item can be associated with one or more categories 226.

The time graph region 225 displays timeline information of one or more patients with respect to the TCM process. The time graph region 225 includes a patient region 228, an IC deadline region 240, and a timeline region 242. The patient region 228 includes a listing of patients that are associated with the health care provider, e.g., patients 244a, 244b, 244c, 244d, and 244e (collectively referred to as patients 244). The IC deadline regions 240 includes an IC deadline status associated with each of the patients 244. That is, whether the IC deadline, e.g., timing threshold, is satisfied or not satisfied, described further below. In the illustrated example, the IC deadline is indicated as satisfied for patients 244a, 244b, and 244d, graphically indicated by the checkmark; and not satisfied for patients 244c and 244e, graphically illustrated by the cross mark.

The timeline region 242 displays a graphical illustration of a timeline of the status of each patient 244 with respect to one or more time thresholds. In the illustrated example, the time deadlines include zero days, seven days, fourteen days, and thirty days; however, other time deadlines are possible. In some examples, the time deadlines are associated with calendar days (e.g., Sunday-Saturday). In some examples, the time deadlines are associated with business days (e.g., Monday-Friday). That is, only business days are included with respect to time deadlines. To that end, as the patient 244 progresses through the TCM process, the respective timeline region 242 is updated. For example, timeline 246a associated with the patient 244a indicates that the patient 244a is currently at day six of the TCM process and the IC requirement is satisfied; timeline 246b associated with the patient 244b indicates that the patient 244b is currently at day ten of the TCM process and is currently awaiting FF communication and satisfied the IC requirement; timeline 246c associated with the patient 244c indicates that the patient 244c is currently at day eleven of the TCM process and has not satisfied the IC requirement; timeline 246d associated with the patient 244d indicates that the patient 244d is currently at day sixteen of the TCM process, has satisfied the FF and IC requirement, and is awaiting to be billed; and timeline 246e associated with the patient 244e indicates that the patient 244e is currently at day thirty-two of the TCM process, has not satisfied the IC and/or the FF requirement, and is ready to be dropped from the TCM process.

FIG. 2C illustrates the dashboard 220 after adding a patient to the TCM process. Specifically, patient 244f is added, indicated by the update to the number of patients associated with the TCM process category 224d, e.g., from five patients to six patients. Further, as patient 244f is recently added to the TCM process, the items due today category 226a is updated to include four items, and further that the awaiting IC category 226b is updated to include one item. Additionally, the time graph region 225 is updated to include the patient 244f, including an associated IC deadline region 240 indicating that the IC deadline is two days, and further a timeline 246f is updated to indicate that the patient 244f is currently at day one of the TCM process and is awaiting IC.

FIG. 2D illustrates the display region 214 when the messages category 216b is selected. Specifically, the display region 214 includes a messaging panel 248 and a message display 250. The messaging panel 248 includes messages 252 that are associated with the health care provider and patients, e.g., patients 244. The messaging panel 248 further includes filters 254a and 254b to filter the messages, e.g., by open or closed messages. The messaging panel 248 also includes a fillable text box 248 for searching the messages 252 by user-input keywords. The message display 250 displays message details for a selected message 252, including correspondence 256a from the patient and correspondence 256b from the healthcare provider. In some examples, the messaging panel 248 can be utilized by the healthcare provider to satisfy the IC requirement to the patient as part of the TCM process.

FIG. 2E illustrates the display region 214 when the telemedicine category 216c is selected. Specifically, the display region 214 includes an appointment region 258 and a details region 259. The appointment region 258 provides an interface for the particular health care provider to provide information with respect to scheduling an appointment, e.g., a FF communication, with a patient. In the illustrated example, the appointment region 258 includes a patient name category 260a, a provider category 260b, a date category 260c, a time category 260d, a duration category 260e, and a purpose category 260f The details region 260 includes a telemedicine details tab 262a and a patient details tab 262b.

FIG. 2F illustrates the telemedicine details tab 262a. Specifically, the telemedicine details tab 262a displays information for a selected patient appointment, e.g., name, provider, date, time, duration, purpose, status, and time until meeting. The telemedicine details tab 262a also provides a notes section 264 for providing notes by the particular health care provider regarding the telemedicine session.

FIG. 2G illustrates the patient details tab 262b. To that end, upon selection of the patient details tab 262b, the display region 214 is further updated to display a patient details tab 266a, a TCM flow tab 266b, and a documents tab 266c. The patient details tab 266a displays information for a patient associated with an appointment, e.g., the appointment detailed by the tab 262a, including personal, account and contact details.

FIG. 2H illustrates the display region 214 when the patients category 216d is selected. Specifically, the display region 214 includes a patients region 268 and a details region 270. The patients region 268 provides a listing of patients associated with the health care provider. The patients region 268 can further include filters 271a and 271b to filter the patients, e.g., active or inactive patients. For a selected patient 273a, e.g., a patient currently within the TCM process, the details region 270 includes a patient details tab 272a, a TCM flow tab 272b, and a documents tab 272c. The TCM flow tab 272b includes a TCM flow region 274a, an actions region 274b, and a TCM log region 274c.

The TCM flow region 272b displays information regarding the patient of the selected appointment within the TCM process. Specifically, the TCM flow region 274a includes a stage region 275a, a status region 275b, and a date region 275c. The stage region 275a displays information regarding the status of the stage of the patient within the TCM process, e.g., discharged, IC, FF, bill. The status region 275b displays information regarding the status of the corresponding stage, e.g., completed, patient is to be billed on. In some examples, a formatting (e.g., color) of the text of information within the status region 275b is based on whether a requirement was satisfied (e.g., the IC requirement). The date region 275c displays the date associated with the corresponding stage (e.g., a date a corresponding stage was updated, or a future date for a corresponding stage to occur). The actions region 274b includes actions 277 that when selected, can update the status of the patient with respect to the TCM process. For example, such actions can include updating the status of the patient to indicate “Readmitted within TCM,” “Admit to Nursing Home,” and “Drop from TCM.” The TCM log region 274c displays information related to prior TCM transactions for the patient.

FIG. 2I illustrates the display region 214 when the patients category 216d is selected, and further, for a different patient than describe above. Specifically, for a selected patient 273b, the TCM flow tab 272b is updated. The selected patient 273b is a patient not currently within the TCM process, but was previously within the TCM process for a previous medical condition. Thus, the TCM flow region 274a does not include any current TCM process data. Further, the TCM log region 274c is updated to include historical TCM data. Specifically, the TCM log region 274c includes a stage region 276a, a date region 276b, and a description region 276c. The stage region 276a displays information regarding the status of a previous stage of the patient within the TCM process, e.g., discharged, IC, FF, readmission, billed. The date region 276b displays the date that the corresponding stage was updated. The description region 276c displays information regarding any further notes related to the corresponding stage, e.g., the heath care provider, who entered the data, etc.

FIG. 2J illustrates the display region 214 when the providers category 216e is selected. Specifically, the display region 214 includes a providers region 278 and a details region 280. The providers region 278 provides a listing of health care providers, e.g., health care providers associated with a particular health care management facility, or with a particular network of health care providers. For a selected health care provider 282a, the details region 280 displays information such as personal, account, and contact details.

FIG. 2K illustrates the display region 214 when the billing report sub-category 218g is selected. Specifically, the display region 214 includes a billing report region 284. The billing report region 284 includes billing details of one or more of the patients. The billing report region 284 can include such billing details, for a respective patient, as date of birth, date of service, complexity level, and relevant billing codes.

FIG. 2L illustrates the display region 214 when the patient activity report sub-category 218h is selected. Specifically, the display region 214 includes a patient activity report region 286. The patient activity report region 286 includes patient details of the patient with respect to the current TCM process. The patient activity report region 286 can include such patient details, for a respective patient, as discharge date, IC details, and FF details.

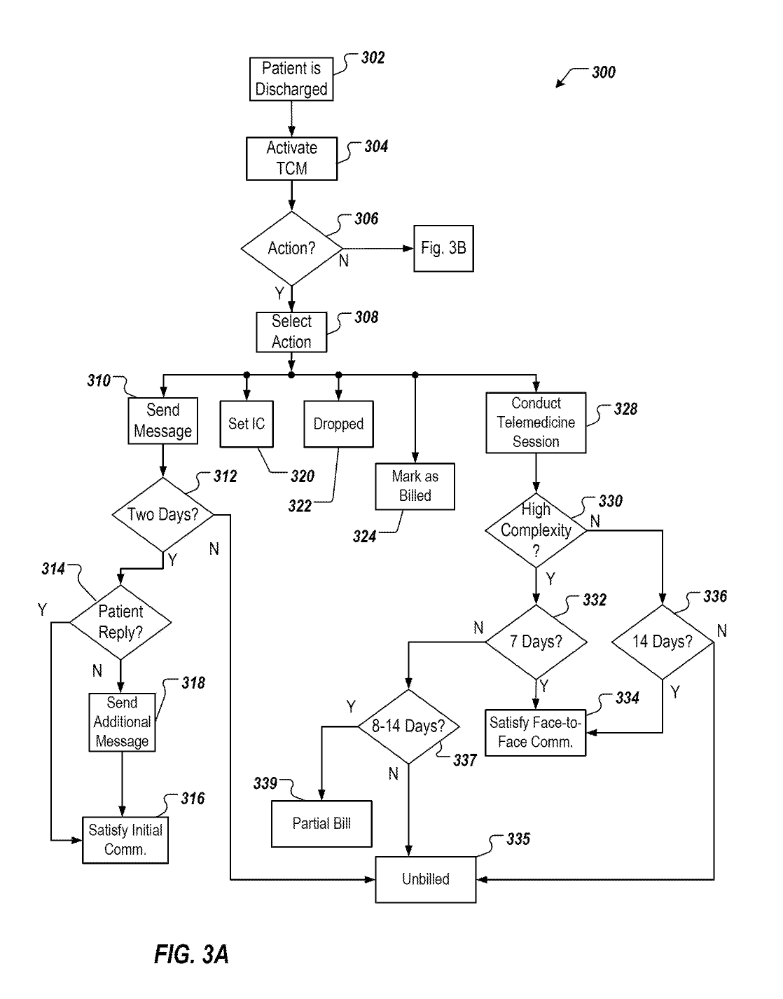

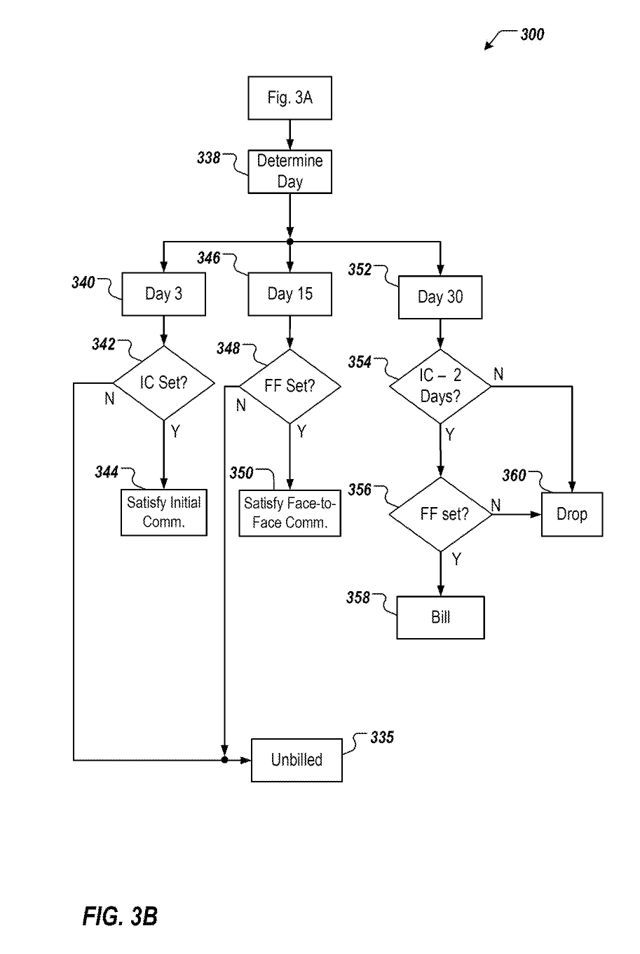

FIGS. 3A and 3B depict an example process 300 that can be executed in accordance with implementations of the present disclosure. The example process 300 can be implemented, for example, by the example environment 100 of FIG. 1. In some examples, the example process 300 can be provided by one or more computer-executable programs executed using one or more computing devices.

A patient is discharged (302). For example, the system 108 can receive data indicating that one of the patients is discharged from an appropriate health care management facility (e.g., hospital, or urgent care facility). The data can be provided to the TCM computing system 108 by a computing system of the appropriate health care management facility, e.g., over the network 102. The TCM process is activated (304). For example, the TCM computing system 108, in response to receiving the data indicating that one of the patients 110 is discharged from the health care management facility, activates the TCM process. In some examples, activation of the TCM process includes initializing the TCM process, e.g., for a particular patient and a particular medical condition. In some examples, activation of the TCM process includes activating the TCM process after a prior initialization of the TCM process.

It is determined whether an action is to be performed (306). For example, the TCM computing system 108 can determine whether an action is to be performed within the TCM process. If it is determined that an action is to be performed, an action is selected (308). For example, the TCM computing system 108 can select an action from multiple actions to be performed. The selection of the action can be based on, among other things, a status of the patient with respect to the TCM process.

The messaging action is selected (310). For example, the TCM computing system 108 can select a messaging action to perform within the TCM process. In some examples, the messaging action includes providing a message to the patient of the current TCM process. Providing the message to the patient can include providing a message through the interface illustrated in FIG. 2D, or through other telecommunication systems, e.g., e-mail, text messaging, instant messaging, and the like, that are in integrated with the TCM process. In some examples, the messaging action is performed first with relation to other possible actions. For example, the messaging action occurs prior to selecting the telemedicine session action 328.

It is determined whether an initial communication is performed within two days of receiving the data indicating that the patient is discharged (312). That is, the TCM computing system 108, based on selecting the messaging action (308), identifies i) a communication event, e.g., the initial communication to be provided to the user, and ii) a time threshold associated with the communication event, e.g., two days. In some examples, the time threshold associated with the communication event, e.g., the initial communication, can include any amount of time, e.g., one day, three days, one week. In some examples, the time threshold is associated with calendar days (e.g., Sunday-Saturday). In some examples, the time threshold is associated with business days (e.g., Monday-Friday). That is, only business days are included with respect to time thresholds. In some examples, the initial communication is performed at an originating site, e.g., a location associated with the health care provider. In some examples, the day of discharge is included as the first day when determining whether the initial communication is performed within the two days. In some examples, the day of discharge is not included as the first day when determining whether the initial communication is performed within the two days.

If it is determined that the initial communication is performed within the two days, it is further determined whether the patient has provided a response (314). That is, in response to determining the time threshold associated with the communication event, e.g., a time threshold of two days associated with the initial communication event, is satisfied, the TCM computing system 108 determines whether the patient has provided a response to the message action, e.g., the initial communication event. For example, the patient can provide a response to the message action through the interface illustrated in FIG. 2D, or through other telecommunication systems, e.g., e-mail, text messaging, instant messaging, and the like, that are integrated with the TCM process. The response by the patient can be received by the TCM computing system 108, and provided to the health care provider, e.g., through the interface illustrated in FIG. 2D. If it is determined that the initial communication is not performed within the two days, the patient remains in the TCM process, but is associated with a status of unbillable (335), e.g., as indicated within a profile associated with the patient that is stored by the database 116.

If it is determined that the patient has provided a response to the message action, the initial communication of the TCM process is satisfied (316). That is, in response to determining that the patient has provided a response to the message action, the TCM computing system 108 determines that the communication event, e.g., the initial communication, is satisfied. For example, within the TCM process, the status of the initial communication for the patient is associated with a satisfied status, e.g., as indicated within a profile associated with the patient that is stored by the database 116.

If it is determined that the patient has not provided a response to the messaging action, an additional message is provided to the patient (318). That is, in response to determining that the patient has not provided a response to the messaging action, the TCM computing system 108 performs a second communication event. For example, the patient has not provided a response to the messaging action through the interface illustrated in FIG. 2D, or through other telecommunication systems, e.g., e-mail, text messaging, instant messaging, and the like, that are integrated with the TCM process. In some examples, the TCM computing system 108 can provide the additional message to the patient through the interface illustrated in FIG. 2D, or through other telecommunication systems, e.g., e-mail, text messaging, instant messaging, and the like, that are integrated with the TCM process.

In response to providing the additional message to the patient, the initial communication of the TCM process is satisfied (316). That is, in response to performing the second communication event, the TCM computing system 108 determines that the first communication event, e.g., the initial communication, is satisfied. For example, within the TCM process, the status of the initial communication for the patient is associated with a satisfied status, e.g., as indicated within a profile associated with the patient that is stored by the database 116.

Other events can be selected, including setting the initial communication (320), dropping the patient from the TCM process (322), and/or marking the patient as billed within the TCM process (324). In particular, setting the initial communication (320) can include satisfying the initial communication (e.g., at (316)). That is, within the TCM process, the status of the initial communication for the patient is associated with a satisfied status, e.g., as indicated within a profile associated with the patient that is stored by the database 116. Dropping the patient from the TCM process (322) can include removing the patient from the TCM process. That is, within the TCM process, the status of the patient is indicated as dropped, or similar identification, e.g., as indicated within a profile associated with the patient that is stored by the database 116. Marking the patient as billed within the TCM process (324) can include updating the status associated with the patent as billed. That is, within the TCM process, the status of the patient is indicated as billed, or similar identification, e.g., as indicated with a profile associated with the patient that is stored by the database 116.

In some examples, a telemedicine session action is conducted (328). That is, the TCM computing system 108 can select a telemedicine session action to be performed within the TCM process. The telemedicine session action is associated with the patient. It is determined whether the medical condition associated with the patient is high complexity (330). That is, based on selecting the telemedicine session action, the TCM computing system 108 identifies a complexity level associated with the medical condition of the user. Further, the medical condition is associated with the current telemedicine session action. In some examples, the TCM computing system 108 can receive data indicating the medical condition complexity associated with the patient from an appropriate health care management facility (e.g., hospital, or urgent care facility). The data can be provided by a computing system of the appropriate health care management facility, e.g., over the network 102. In some example, other complexity levels can be determined, such as low complexity or moderate complexity. In some examples, it can be determined whether the medical condition associated with the patient is not a high complexity.

If it is determined that the medical condition associated with the patient is high complexity, it is determined whether a face-to-face (FF) communication event is conducted within seven days (332). That is, it is determined that the complexity level includes a first, e.g., high, complexity level, and in response, the TCM computing system 108 identifies i) a communication event, e.g., the FF communication event, and ii) a time threshold, e.g., seven days, associated with the communication event. In some examples, the time threshold associated with the communication event, e.g., the FF communication event, can include any amount of time, e.g., one day, one week, one month. In some examples, the time threshold is associated with calendar days (e.g., Sunday-Saturday). In some examples, the time threshold is associated with business days (e.g., Monday-Friday). That is, only business days are included with respect to time thresholds. In some examples, the day of discharge is included as the first day when determining whether the FF communication event is performed within the seven days. In some examples, the day of discharge is not included as the first day when determining whether the FF communication event is performed within the seven days.

If it is determined that the FF communication event is conducted within seven days, the FF communication of the TCM process is satisfied (334). That is, it is determined that the time threshold, e.g., seven days, associated with the communication event, e.g., the FF communication event, is satisfied, and in response, the TCM computing system 108 determines that the communication event, e.g., the FF communication, is satisfied. For example, within the TCM process, the status of the FF communication for the patient for the medical condition is associated with a satisfied status, e.g., as indicated within a profile associated with the patient that is stored by the database 116. If it is determined that the FF communication event is not conducted within seven days, it is determined whether the FF communication event is conducted within eight to fourteen days (337). If it is determined that the FF communication event is conducted within eight to fourteen days, the patient is associated with a status of partially billable (339), e.g., as indicated within a profile associated with the patient that is stored by the database 116. If it is determined that the FF communication event is not conducted within eight to fourteen days, the patient remains in the TCM process, but is associated with a status of unbillable (335), e.g., as indicated within a profile associated with the patient that is stored by the database 116.

If it is determined that the particular medical condition associated with the patient is not high complexity, it is determined whether a FF communication event is conducted within fourteen days (336). That is, it is determined that the complexity level includes a second, e.g., moderate, complexity level, and in response, the TCM computing system 108 identifies a second time threshold, e.g., fourteen days, associated with the FF communication event. In some examples, the second time threshold associated with the first communication event, e.g., the FF communication, can include any amount of time, e.g., one day, one week, one month. In some examples, the second time threshold is less than the first time threshold. In some examples, the first time threshold is less than the second time threshold.

If it is determined that the FF communication event is conducted within fourteen days, the FF communication of the TCM process is satisfied (334). That is, it is determined that the second time threshold, e.g., fourteen days, associated with the communication event, e.g., the FF communication event, is satisfied, and in response, the TCM computing system 108 determines that the communication event, e.g., the FF communication, is satisfied. For example, within the TCM process, the status of the FF communication for the patient for the medical condition is associated with a satisfied status, e.g., as indicated within a profile associated with the patient that is stored by the database 116. If it determined that the FF communication event is not conducted within fourteen days, the patient remains in the TCM process, but is associated with a status of unbillable (335), e.g., as indicated with a profile associated with the patient that is stored by the database 116.

It is determined that an action is not to be performed, it is determined what is the current day of the TCM process with respect to the patient and the medical condition (338). That is, it is determined that an action is not to be performed, and in response, the TCM computing system 108 determines the current day in the TCM process of the patient with respect to the medical condition. It is determined that the current day in the TCM process is day three (340). It is then determined whether the IC was scheduled for the patient and the current medical condition (342). That is, the TCM computing system 108 determines, in response to the current day of the TCM process being day three, whether the IC was conducted between the patient and the health care provider within the preceding two days. For example, conducting the IC can include providing a message to the patient through the interface illustrated in FIG. 2D, or through other telecommunication systems, e.g., e-mail, text messaging, instant messaging, and the like, that are in integrated with the TCM process.

If it is determined that the IC was conducted, the initial communication of the TCM process is satisfied (344). That is, in response to determining that the IC is conducted within the preceding two days, the TCM computing system 108 determines that the communication event, e.g., the initial communication, is satisfied. For example, within the TCM process, the status of the initial communication for the patient for the particular event is associated with a satisfied status, e.g., as indicated within a profile associated with the patient that is stored by the database 116. If it is determined that the IC is not conducted, the patient remains in the TCM process, but is associated with a status of unbillable (335), e.g., as indicated with a profile associated with the patient that is stored by the database 116. In some examples, the status of the patient is additionally marked as missed.

It is determined that the current day in the TCM process is day fifteen (346). It is then determined whether the FF was conducted for the patient and the current medical condition (348). That is, the TCM computing system 108 determines, in response to the current day of the TCM process being day fifteen, whether the FF was conducted between the patient and the health care provider. If it is determined that the FF is conducted, the FF communication of the TCM process is satisfied (350). That is, in response to determining that the FF is conducted, the TCM computing system 108 determines that the communication event, e.g., the FF communication, is satisfied. For example, within the TCM process, the status of the FF communication for the patient for the particular event is associated with a satisfied status, e.g., as indicated within a profile associated with the patient that is stored by the database 116. If it is determined that the FF is not conducted, the patient remains in the TCM process, but are associated with a status of unbillable (335), e.g., as indicated with a profile associated with the patient that is stored by the database 116.

It is determined that the current day in the TCM process is day thirty (352). It is then determined whether the IC is conducted for the patient and the medical condition within two days (354). That is, the TCM computing system 108 determines, in response to the current day of the TCM process being day thirty, whether the IC is conducted between the patient and the health care provider within a threshold, e.g., two days. For example, conducting the IC can include providing a message to the patient through the interface illustrated in FIG. 2D, or through other telecommunication systems, e.g., e-mail, text messaging, instant messaging, video conference, and the like, that are in integrated within the TCM process. If it is determined that the IC is conducted within two days, it is then determined whether the FF is conducted for the patient and the medical condition within seven days or fourteen days, depending on the level of complexity (356). That is, the TCM computing system 108 determines, in response to the IC conducted within the threshold, e.g., two days, whether the FF is conducted between the patient and the health care provider within a threshold, e.g., seven days or fourteen days, as appropriate.

If it is determined that the FF is conducted within the threshold, e.g., seven days or fourteen days, as appropriate, the patient is marked as billed within the TCM process (358). That is, within the TCM process, the status of the patient for the medical condition is indicated as billed, marked as billed, or similar identification, e.g., as indicated within a profile associated with the patient that is stored by the database 116. If it is determined that the FF is not conducted within the threshold, e.g., seven days or fourteen days, as appropriate, the patient is dropped from the TCM process (360). That is, within the TCM process, the status of the patient is indicated as dropped, or similar identification, e.g., as indicated with a profile associated with the patient that is stored by the database 116. If it is determined that the IC is not conducted within the threshold, e.g., two days, the patient is dropped from the TCM process for the particular medical condition (360). That is, within the TCM process, the status of the patient is indicated as dropped, or similar identification, e.g., as indicated with a profile associated with the patient that is stored by the database 116.

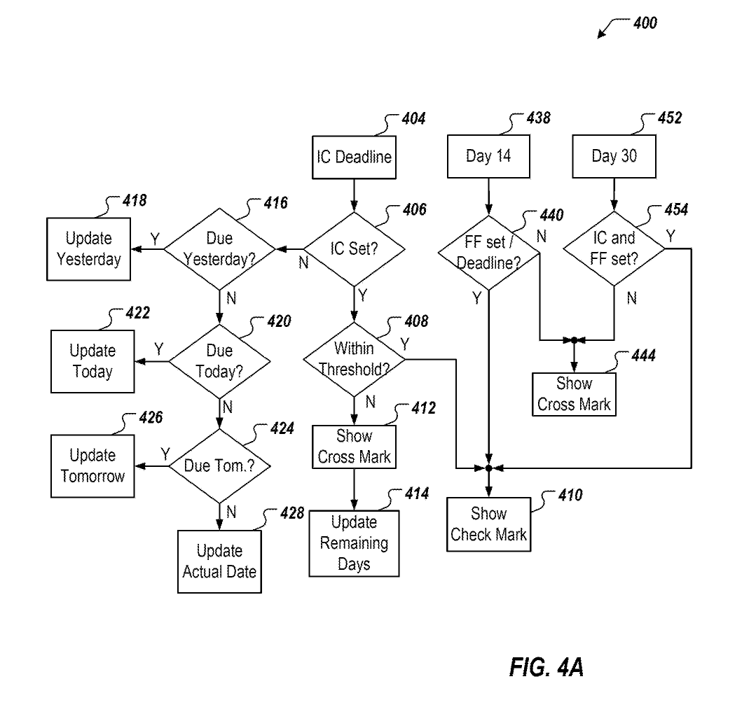

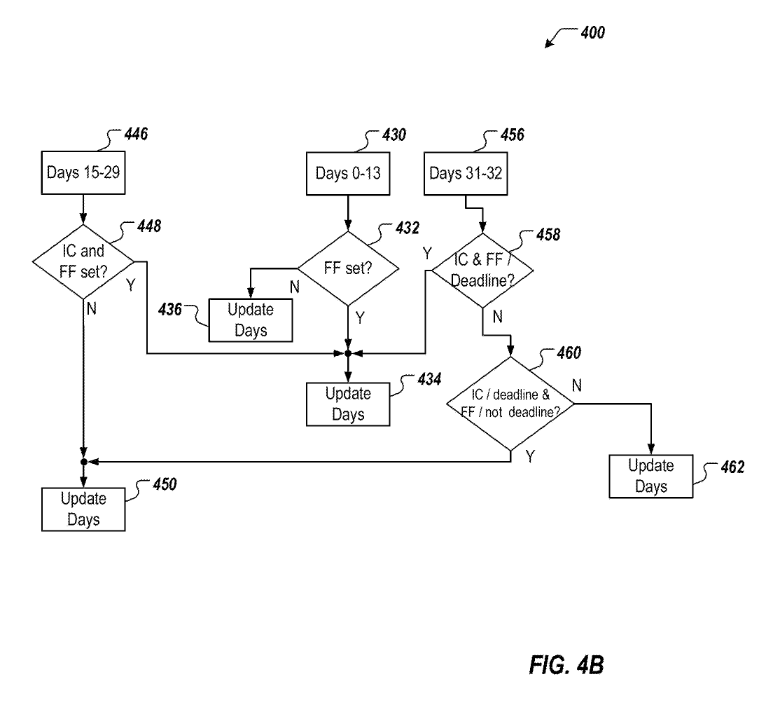

FIGS. 4A and 4B depicts an example process 400 that can be executed in accordance with implementations of the present disclosure. The example process 400 can be implemented, for example, by the example environment 100 of FIG. 1. In some examples, the example process 400 can be provided by one or more computer-executable programs executed using one or more computing devices. In some examples, documentation of an event, e.g., an IC or FF, can be manually edited by an administrator or health care provider associated with the TCM process.

The IC deadline is identified (404). That is, the TCM computing system 108 identifies the appropriate IC deadline for the patient. For example, the TCM computing system 108 updates the IC deadline region 240, as illustrated in FIG. 2B. To appropriately update the IC deadline region 240, it is determined whether the IC is documented between the patient and the health care provider (406). That is, in response to the IC deadline being identified, the TCM computing system 108 determines whether the IC is documented between the patient and the health care provider.

If it is determined that the IC is documented, it is determined whether the IC is documented within a time threshold (408). That is, it is determined that the IC is documented, and in response, the TCM computing system 108 determines whether the IC is documented within a time threshold, e.g., two days. If it is determined that the IC is documented within the time threshold, the appropriate IC deadline region 240 is updated to illustrate a checkmark (410). That is, it is determined that the IC is documented within the time threshold, e.g., two business days, and the TCM computing system 108 updates the IC deadline region 240 to illustrate the checkmark, as illustrated in the IC deadline region 240 associated with the patient 244a in FIG. 2

If it is determined that the IC has not been documented within the time threshold, the appropriate IC deadline region 240 is updated to illustrate a cross mark (e.g., an “X) (412). That is, it is determined that the IC is not scheduled within the time threshold, e.g., two days, and the TCM computing system 108 updates the IC deadline region 240 to illustrate the cross mark, as illustrated in the IC deadline region 240 associated with the patient 244c in FIG. 2B. Further, the graphical representation associated with the remaining days are updated (414). For example, the TCM computing system 108 updates the timeline 246c in FIG. 2B to indicate a first color (e.g., gray) associated with each day, e.g., up until the current day.

If it is determined that the IC is not documented, it is determined whether the IC is due the prior day (416). That is, it is determined that the IC is not documented, and in response, the TCM computing system 108 determines whether the IC is due the prior day. If it is determined that the IC is due the prior day, the graphical illustration corresponding to the prior day is updated (418). That is, the TCM computing system 108 updates the timeline 246 of the associated patient to indicate a second color (e.g., red) associated with the previous day.

If it is determined that the IC is not due the prior day, it is determined whether the IC is due the current day (420). That is, it is determined that the IC is not due the prior day, and in response, the TCM computing system 108 determines whether the IC is due the current day. If it is determined that the IC is due the current day, the graphical illustration corresponding to the current day is updated (422). That is, the TCM computing system 108 updates the timeline 246 of the associated patient to indicate the second color (e.g., red) associated with the current day. If it is determined that the IC is not due the current day, it is determined whether the IC is due the next day (424). That is, it is determined that the IC is not due the current day, and in response, the TCM computing system 108 determines whether the IC is due the next day.

If it is determined that the IC is due the next day, the graphical illustration corresponding to the next day is updated (426). That is, the TCM computing system 108 updates the timeline 246 of the associated patient to indicate the second color (e.g., red) associated with the next day. If it is determined that the IC is not due the next day, the graphical illustration corresponding to the actual date is updated (428). That is, the TCM computing system 108 updates the timelines 246 of the associated patient to indicate the second color (e.g., red) associated with the actual date of the IC.

Days zero through thirteen are identified (430). That is, the TCM computing system 108 identifies the appropriate timeline 246 of the patient to appropriately update the graphical illustration of days zero through thirteen. To appropriately update the graphical illustration of days zero through thirteen, it is determined whether the FF is documented between the patient and the health care provider (432). That is, the TCM computing system 108 determines whether the FF is documented between the patient and the health care provider for the medical condition. In response to determining that the FF is documented, the graphical illustration corresponding to days zero through thirteen are updated (434). That is, the TCM computing system 108 updates the time timeline 246 of the associated patient to indicate a third color (e.g., blue). In response to determining that the FF is not documented, the graphical illustration corresponding to days zero through thirteen are updated (436). That is, the TCM computing system 108 updates the time timeline 246 of the associated patient to indicated a fourth color (e.g., light grey).

Day fourteen is identified (438). That is, the TCM computing system 108 identifies the appropriate timeline 426 of the associated patient to appropriately update the graphical illustration of day fourteen. To appropriately update the graphical illustration of day fourteen, it is determined whether the FF is scheduled, e.g., documented, between the patent and the health care provider within a time threshold (440). That is, the TCM computing system 108 determines whether the FF is documented between the patient and the health care provider for the medical condition within the time threshold, e.g., fourteen days. In response to determining that the FF is scheduled within the time threshold, the graphical illustration corresponding to day fourteen is updated (410). That is, it is determined that the FF is scheduled within the time threshold, e.g., fourteen days, and the TCM computing system 108 updates the timeline 246 to illustrate a checkmark corresponding to day fourteen, as illustrated in the IC deadline region 240 associated with the patient 244d in FIG. 2B.

Days fifteen through twenty-nine are identified. That is, the TCM computing system 108 identifies the appropriate timeline 426 of the associated patient to appropriately update the graphical illustration of days fifteen through twenty-nine. To appropriately update the graphical illustration of days fifteen through twenty-nine, it is determined whether the IC and the FF are documented between the patient and the health care provider (448). That is, the TCM computing system 108 determines whether the FF and the IC are documented for the patient for the medical condition. In response to determining that the FF and the IC are documented, the graphical illustration corresponding to days fifteen through twenty-nine are updated (434). That is, the TCM computing system 108 updates the timeline 246 of the patient to indicate the third color (e.g., blue). In response to determining that the FF and the IC are not documented, the graphical illustration corresponding to days fifteen through twenty-nine are updated (450). That is, the TCM computing system 108 updates the timeline 246 of the associated patient to indicate the second color (e.g., red).

Day thirty is identified (452). That is, the TCM computing system 108 identifies the appropriate timeline 426 of the associated patient to appropriately update the graphical illustration of day thirty. To appropriately update the graphical illustration of day thirty, it is determined whether the FF and the IC are documented between the patient and the health care provider (454). That is, the TCM computing system 108 determines whether the FF and the IC are documented for the patient for the medical condition. In response to determining that the FF and the IC are documented, the graphical illustration corresponding to day thirty is updated (410). That is, it is determined that the FF and the IC are documented, and the TCM computing system 108 updates the timeline 246 to illustrate a checkmark corresponding to day thirty. In response to determining that the FF and the IC are not documented, the graphical illustration corresponding to day thirty is updated (444). That is, it is determined that the FF and the IC are not scheduled, and the TCM computing system 108 updates the timeline 246 to illustrate a cross mark corresponding to day thirty.

Days thirty-one and thirty-two are identified (456). That is, the TCM computing system 108 identifies the appropriate timeline 426 of the associated patient to appropriately update the graphical illustration of days thirty-one and thirty-two. To appropriately update the graphical illustration of days thirty-one and thirty-two, it is determined if the IC and the FF are documented within respective timing thresholds (458). That is, the TCM computing system 108 determines whether the IC and the FF are documented for the patient for the medical condition with the respective time threshold, e.g., two days and seven days or fourteen days, as appropriate. In response to determining that the IC and the FF are scheduled within the respective time thresholds, the graphical illustration corresponding to days thirty-one and thirty-two are updated (434). That is, it is determined that the IC and the FF are documented within the respective time thresholds, e.g., two days and seven days or fourteen days, as appropriate, and the TCM computing system 108 updates the timeline 246 of the associated patient to indicate the third color (e.g., blue).

In response to determining that the IC and/or the FF are not documented within the respective time thresholds, it is determined whether the IC is scheduled within the respective time threshold and the FF is not documented within the respective threshold (460). That is, it is determined that the IC and/or the FF are not documented within the respective time thresholds, e.g., two days and seven days or fourteen days, as appropriate, and the TCM computing system 108 determines whether the IC is scheduled for the patient for the medical condition within the respective time threshold, e.g., two days, and the FF is not documented for the patient for the medical condition within the respective time threshold, e.g., seven days or fourteen days, as appropriate. In response to determining that the IC is documented within the respective time threshold and the FF is not scheduled within the respective time threshold, the graphical illustration corresponding to days thirty-one and thirty-two are updated (450). That is, the TCM computing system 108 updates the timeline 246 of the associated patient to indicate the second color (e.g., red). In response to determining that the IC and the FF are not documented within the respective time thresholds (462), the graphical illustration corresponding to days thirty-one and thirty-two are updated (462). That is, the TCM computing system 108 updates the timeline 246 of the associated patient to indicated a fifth color (e.g., dark grey).

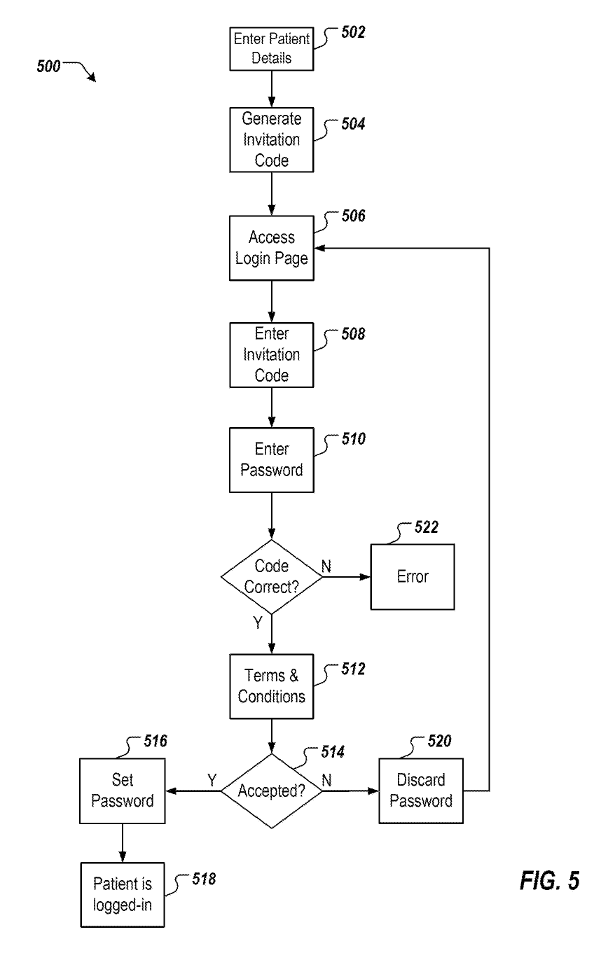

FIG. 5 depicts an example process 500 that can be executed in accordance with implementations of the present disclosure. The example process 500 can be implemented, for example, by the example environment 100 of FIG. 1. In some examples, the example process 500 can be provided by one or more computer-executable programs executed using one or more computing devices.

Patient details are provided (502). That is, the TCM computing system 108 can receive patient detail data that is provided by a computing system of the appropriate health care management facility, e.g., over the network 102. In some examples, the patient detail data can include demographic information, including username and preferred notification method, e.g., text message, e-mail. The patient detail data can be associated with a user profile of the patient. An invitation code is generated (504). That is, the TCM computing system 108 can generate the invitation code that is provided to the patient. In some examples, the invitation code can include any alphanumeric combination, or a quick response (QR) code. In some examples, the invitation code can be provided to the patient through the preferred communication method, e.g., text message, e-mail, as indicated in the patient details.

The login page is accessed (506). That is, the patient accesses the login page, e.g., the login electronic document 202, through the associated computing device, e.g., patient computing device 104. The invitation code is provided to the login page (508). That is, the patient responds to the previously generated invitation code through the accessed login page, e.g., the login electronic document 202. In some examples, the QR code is recognized, e.g., by the appropriate computing device. The login credentials are provided to the login page (510). That is, the patient provides the login credentials, e.g., the username, through the accessed login page, e.g., the login electronic document 202.

It is determined whether the invitation code is correct (512). That is, the appropriate computing device determines whether the provided code, e.g., by the patient, is the same as the invitation code associated with the user profile of the patient. If it is determined that the provided invitation code is correct, e.g., matches the stored invitation code, terms and conditions associated with the TCM process are provided for display (514). That is, the appropriate computing device provides for the display the terms and conditions for the patient, and further, an option to accept or deny the terms and conditions of the TCM process.

In response to determining that the terms and conditions are accepted by the patient, the previously provided password is accepted as associated with the patient for login to the TCM process (516). That is, the user profile is associated with an indication that the terms and conditions are accepted, and the user profile is further associated with the previously provided password. The patient is logged into the TCM process (518). That is, the patient has access to interact with the TCM process. In response to determining that the terms and conditions are not accepted by the patient, the previously provided password is discarded (520). That is, the patient provided input indicating the terms and conditions are not accepted, and in response, the user profile is not associated with the previously provided password. Additionally, in some examples, the patient can provide comments for not accepting the terms and conditions, e.g., through the appropriate computing device. In some examples, the process returns to the accessing the login page (506). If it is determined that provided invitation code is not correct, e.g., does not match the stored invitation code, an error message is provided for display to the patient (522).

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method, comprising:
determining that an action is to be performed, and in response, selecting a telemedicine session action to be performed, the telemedicine session action associated with a user;
based on selecting the telemedicine session action, identifying a complexity level associated with a medical condition of the user, the medical condition associated with the telemedicine session action;
determining that the complexity level includes a first complexity level, and in response, identifying i) a first communication event and ii) a first time threshold associated with the first communication event; and
determining that the first time threshold is satisfied, and in response, satisfying the first communication event.

2. The computer-implemented method of claim 1, wherein the first complexity level includes a high complexity level.

3. The computer-implemented method of claim 1, further comprising:
determining that the complexity level includes a second complexity level, and in response, identifying a second time threshold associated with the first communication event;
determining that the second time threshold is satisfied, and in response, satisfying the first communication event.

4. The computer-implemented method of claim 3, wherein the second time threshold is less than the first time threshold.

5. The computer-implemented method of claim 3, wherein the first communication event includes a face-to-face medical session to be performed that is associated with the user.

6. The computer-implemented method of claim 1, wherein determining that the action is to be performed further comprises, in response, selecting a message action, the message action including providing a message to the user, the method further comprising:
based on selecting the message action, identifying i) a second communication event and ii) a third time threshold associated with the second communication event;
determining that the third time threshold is satisfied, and in response, determining whether the user has provided a response to the message action;
in response to determining that the user has provided the response to the message action, satisfying the second communication event; and
in response to determining that the user has not provided the response to the message action, performing a third communication event, and in response, satisfying the second communication event.

7. The computer-implemented method of claim 6, wherein the third time threshold is less than the first time threshold.

8. The computer-implemented method of claim 6, wherein the second communication event includes an initial communication to be provided to the user.

9. The computer-implemented method of claim 8, wherein the third communication event includes an additional communication to be provided to the user.

10. The computer-implemented method of claim 6, wherein selecting the message action occurs prior to selecting the telemedicine session action.

11. A system comprising:
a data store for storing data; and
one or more processors configured to interact with the data store, the one or more processors being further configured to perform operations comprising:
determining that an action is to be performed, and in response, selecting a telemedicine session action to be performed, the telemedicine session action associated with a user;
based on selecting the telemedicine session action, identifying a complexity level associated with a medical condition of the user, the medical condition associated with the telemedicine session action;
determining that the complexity level includes a first complexity level, and in response, identifying i) a first communication event and ii) a first time threshold associated with the first communication event; and
determining that the first time threshold is satisfied, and in response, satisfying the first communication event.

12. The system of claim 11, wherein the first complexity level includes a high complexity level.

13. The system of claim 11, the operations further comprising:
determining that the complexity level includes a second complexity level, and in response, identifying a second time threshold associated with the first communication event;
determining that the second time threshold is satisfied, and in response, satisfying the first communication event.

14. The system of claim 13, wherein the second time threshold is less than the first time threshold.

15. The system of claim 13, wherein the first communication event includes a face-to-face medical session to be performed that is associated with the user.

16. The system of claim 11, wherein determining that the action is to be performed further comprises, in response, selecting a message action, the message action including providing a message to the user, the operations further comprising:
based on selecting the message action, identifying i) a second communication event and ii) a third time threshold associated with the second communication event;
determining that the third time threshold is satisfied, and in response, determining whether the user has provided a response to the message action;
in response to determining that the user has provided the response to the message action, satisfying the second communication event; and
in response to determining that the user has not provided the response to the message action, performing a third communication event, and in response, satisfying the second communication event.

17. A computer readable medium storing instructions that, when executed by one or more processors, cause the one or more processors to perform operations comprising:
determining that an action is to be performed, and in response, selecting a telemedicine session action to be performed, the telemedicine session action associated with a user;
based on selecting the telemedicine session action, identifying a complexity level associated with a medical condition of the user, the medical condition associated with the telemedicine session action;
determining that the complexity level includes a first complexity level, and in response, identifying i) a first communication event and ii) a first time threshold associated with the first communication event; and
determining that the first time threshold is satisfied, and in response, satisfying the first communication event.

18. The computer readable medium of claim 17, wherein the first complexity level includes a high complexity level.

19. The computer readable medium of claim 17, the operations further comprising:
determining that the complexity level includes a second complexity level, and in response, identifying a second time threshold associated with the first communication event;
determining that the second time threshold is satisfied, and in response, satisfying the first communication event.

20. The computer readable medium of claim 19, wherein the second time threshold is less than the first time threshold.
